(19) United States
(12) Patent Application Publication
(10) Pub. No.: US 2004/0084914 A1
(43) Pub. Date: May 6, 2004

(54) Pet refuse tool and method

(76) Inventors: Jamshid Karimi, Thousand Oaks, CA (US); Keyvan T. Diba, Los Angeles, CA (US)

Correspondence Address: BIRCH, STEWART, KOLASCH & BIRCH, LLP, 10940 WILSHIRE BOULEVARD, EIGHTEENTH FLOOR, LOS ANGELES, CA, 90024-4450, US

(21) Appl. No.: 10/620,665

(22) Filed: Jul. 16, 2003

Related U.S. Application Data
(60) Provisional application No. 60/396,447, filed on Jul. 17, 2002.

(51) Int. Cl. A01K 29/00

(52) U.S. Cl. 294/1.3

(57) ABSTRACT

A portable pet refuse tool having two relatively movable jaws defining a receiving opening for a piece of refuse, and a disposable bag cartridge removably received between the jaws with a thin-walled plastic bag folded into a storage position with a pull tab accessible at the receiving opening attached to a cartridge slide that is latched in place and has a notch for serving as a closure clip for the bag after the refuse is picked up. The bag is extended out of the tool, folded back over the tool, and lines the receiving opening as the refuse is picked up, and then is pulled partially through the tool with the carrier slide so that the closure clip can be fitted around the bag to close it for disposal. A flashlight seat is provided for illumination, and a thumb hole is provided for ease of carrying. An alternative embodiment has a fixed opening for receiving a bag to be folded around the tool, a movable jaw for pushing refuse into the bag, and a trigger for the movable jaw, and a closure clip is provided for closing the bag in a manner similar to the first embodiment.

### REFERENCE TO PRIOR PROVISIONAL APPLICATION

This application claims the benefit of prior copending provisional application No. 60/396,447, filed Jul. 17, 2002.

### BACKGROUND OF THE INVENTION

This invention relates to a hand tool for picking up pet refuse and the like, and has particular reference to such a tool for placing and confining the refuse in a disposal bag as an incident to the picking-up operation. The invention is well suited for use by a person walking a pet on a leash and cleaning up after the pet, as is appropriate and sometimes required by law in public areas. The tool also is usable for removal of cat refuse from a litter tray, and other tasks of this kind.

Many types of tools and procedures have been proposed or provided for use in picking up and disposing of pet refuse and the like, while avoiding touching of the refuse by the user. One such tool is a combined scoop and pushing tool with which refuse is picked up and then simply dumped in a refuse container. A variation of this, sold as the “Pix It Up” system, uses a square frame on an elongated handle and attaches a bag to the frame to receive the refuse as it is scooped up in the frame. The bag is then detached from the scoop for disposal of the refuse.

Another product is the “Pet Gold Mini Scissors Scoop” sold by Petco and comprising a plastic scissors for slicing under the refuse and then picking it up for deposit in a bag for disposal. Still another is “Allen's Spring Action Scooper”, also sold by Petco, having spring-loaded clamshell jaws for picking up and then depositing the refuse. Another widely used procedure is the use of a simple flexible plastic bag which the user places over the refuse and then closes and grips to contain the refuse in the bag. While simple and effective, this procedure often involves difficult manipulation of the bag and unpleasant contact of the user's hand with the refuse.

### BRIEF DESCRIPTION OF THE INVENTION

The present invention resides in a simple and effective hand tool that receives and holds a flexible bag in which the refuse eventually will be discarded, and a novel method of its use, the tool being capable of relatively simple manipulation and being effective both to pick up the refuse and to enclose the refuse in the flexible bag in a quick and easy operation that avoids all contact between the user and the refuse. The method also provides for simple and effective closing and removal of the bag.

For these purposes, the invention provides a lightweight and compact tool with a handle to be held in one hand, a gripping head on the handle with a “receiving” opening between two relatively movable jaws, the opening being lined, for use, with a flexible bag that receives the refuse when the tool is placed over the refuse. The bag then is pulled into the tool from the handle side of the head to complete the pick-up of the refuse without need for contact with the user's hands. The preferred bag has an attachment on its closed end that serves first as a bag cartridge or carrier for insertion in the tool and, after the refuse has been pulled into the tool, as a closure clip for the bag. The closed and sealed bag then may be separated from the tool and discarded with the enclosed refuse. Conventional flexible plastic bags without the closure clip attachment may be used if the supply of the preferred bags has been exhausted.

Additional features of the invention include the provision of a convenient seat for a miniature flashlight in the tool, positioned to illuminate the area in front of and inside the gripping head, and a conveniently located operating lever on the tool for opening the receiving opening and releasing the jaws to spring-closing action, while also being positioned to serve as a belt clip for carrying the tool. A thumb hole in the end of the handle remote from the gripping head permits the user to carry the refuse tool in the same hand holding a conventional reel for a pet leash while walking the pet.

Other features and advantages of the invention will become apparent from the following detailed description, taken in conjunction with the accompanying drawings.

### BRIEF DESCRIPTION OF THE DRAWINGS

FIG. 1 is a front and top perspective view of a pet refuse tool in accordance with the present invention, shown with a miniature flashlight in the flashlight seat;

FIG. 2 is a side elevational view of the refuse tool of FIG. 1;

FIG. 3 is a top plan view of the refuse tool;

FIG. 4 is a longitudinal cross-sectional view taken substantially along line 4-4 of FIG. 3;

FIG. 5 is a fragmentary side elevational view showing the tool clipped onto the belt (in cross-section) of a user;

FIG. 6 is a cross-sectional view of the tool, similar to FIG. 4, showing the carrying position of a user's hand, in broken lines, and a schematic fragmentary representation of a leash reel held in the user's hand, in outline only;

FIG. 7 is a top perspective view of a bag cartridge for use with the refuse tool of the invention, with a bag shown in folded condition for insertion in the refuse tool;

FIG. 8 is a front and side perspective view showing the refuse tool with the gripping head in the open position and a bag cartridge being inserted into a bag seat in the lower jaw of the head;

FIG. 9 is a top perspective view on a reduced scale showing the beginning of unfolding of the bag from the bag cartridge in the bag seat, by pulling the free open end portion of the bag out of the seat;

FIG. 10 is a side elevational view of the refuse tool and bag of FIG. 9, with the unfolded bag shown in cross-section and being opened preparatory to being folded over the tool;

FIG. 11 is a view similar to FIGS. 8 and 10 with the bag folded over the tool;

FIG. 12 is a view similar to FIGS. 8, 10 and 11 showing the user's hand in the step of forming a pocket by pushing the top wall of the bag into the mouth of the tool;

FIG. 13 is a view similar to FIG. 12 showing another step with the tool and bag in the open condition and held over a piece of pet refuse in position to grip and pick up the refuse;

FIG. 14 is a view similar to FIG. 13, on a slightly reduced scale, showing another step in the sequence after the position shown in FIG. 13, with the tool released and closed on the pet refuse and the user gripping the inner end of the bag, at the carrier, and beginning to pull the bag into and through the gripping head;

FIG. 15 is a view similar to FIG. 14 showing another step, after the bag has been pulled partially through the head and the user is moving the closure clip of the carrier into engagement with the open-end portion of the bag, to enclose the refuse;

FIG. 16 is a view similar to FIG. 15 showing another step in which the clip has been applied and the closed bag is held in the tool ready for disposal;

FIG. 17 is a fragmentary bottom plan view on an enlarged scale of the underside of the gripping head after removal of the bag;

FIG. 18 is a further enlarged fragmentary view taken substantially along line 18-18 of FIG. 2 of the underside of the movable jaw of the gripping head, showing the illumination lines of the flashlight;

FIG. 19A is a top perspective view of an alternative embodiment of the invention;

FIGS. 19B and 19C are fragmentary views showing modifications of the alternative embodiment in FIG. 19A;

FIG. 20 is a view similar to FIG. 13 showing the position of the tool of the alternative embodiment in picking up a piece of refuse and showing the actuation of the tool to push the refuse into a bag fitted into the receiving opening of the tool; and

FIG. 21 is a view similar to FIG. 20 showing the application of the alternative form of the closure clip to the bag.

### DETAILED DESCRIPTION

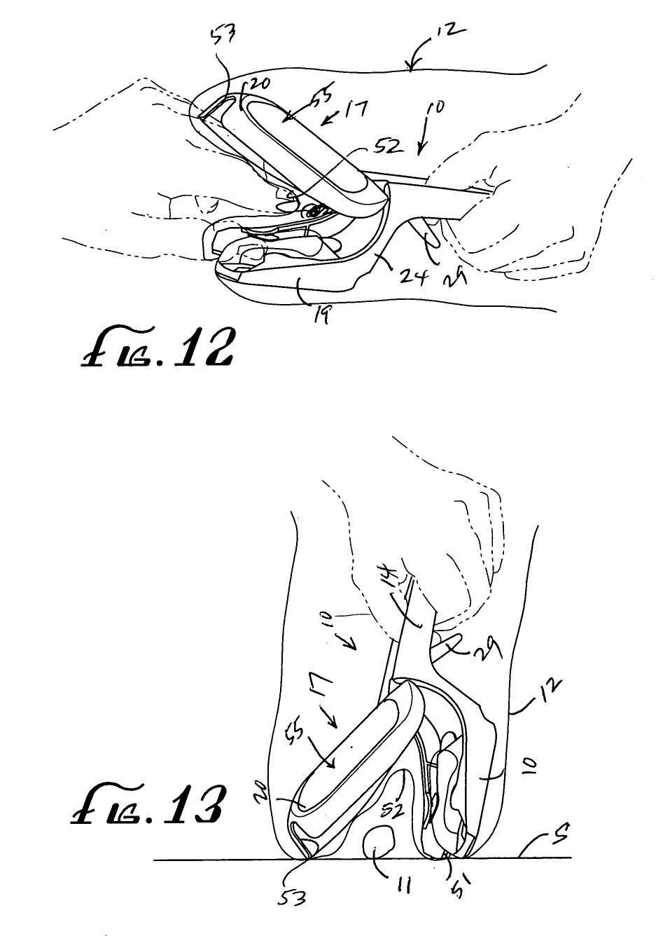

As shown in the drawings for purposes of illustration, the invention is embodied in a portable tool, indicated generally by the reference number 10 in the drawings, for use in picking up refuse such as pet feces or the like, represented generally herein simply as a lump 11 (see FIG. 13), for disposal of the refuse. For example, the tool may be carried by a user during the walking of a pet along a city street or in a park, for use in retrieving the pet's discharged bodily waste, as is always appropriate as a courtesy and sometimes is required by law, and carrying the waste to a suitable disposal point.

As has been noted, this function often is simply performed by carrying a flexible bag and fitting the bag around the refuse to pick it up, then folding the bag around the refuse and depositing it in a refuse container. Various tools have been devised to assist in this process, including those mentioned in the background section hereof, but those tools suffer from various shortcomings, primarily in convenience of operation and the aesthetics of handling the feces. The present invention is designed to reduce those shortcomings.

In accordance with the present invention, the tool 10 is a lightweight and compact implement that can be carried conveniently in one hand and that is easily combined with a flexible bag 12 (see FIGS. 7-13) in a novel manner that enables the user to pick up the refuse 11 in a simple operation, pull the refuse into the tool while enclosed in the bag, and close and seal the bag for disposal, all without contact by the user with the refuse or the portion of the bag containing the refuse. The result is a greatly simplified operation with a minimum of unpleasantness, even for the most sensitive of users.

For these purposes, the tool 10 comprises a handle 14 that can be sized to be gripped in one hand during use, herein being provided with transverse ridges 15 on its upper side for secure gripping. The tool has a gripping head 17 on one end of the handle with a “receiving” opening 18 formed between two relatively movable elements 19 and 20, in the nature of jaws on opposite sides of the opening 18, and the opening is lined, for use, with a flexible bag 12, preferably composed of thin-walled plastic film, with an open-end portion formed by two opposed walls overlying the adjacent sides of the two jaws (see FIG. 13). When the jaws are spread apart to expand the receiving opening, the gripping head 17 is placed over the refuse, thereby placing the bag 12 over the refuse as well, so that closing of the jaws grips the refuse 11 in the receiving opening between opposed walls of the bag. The bag then is pulled farther into the tool to drag the refuse into and through the gripping head, where a closure clip 21 (FIG. 15) can be applied around the bag to seal the refuse in the bag before the bag is completely removed from the tool 10.

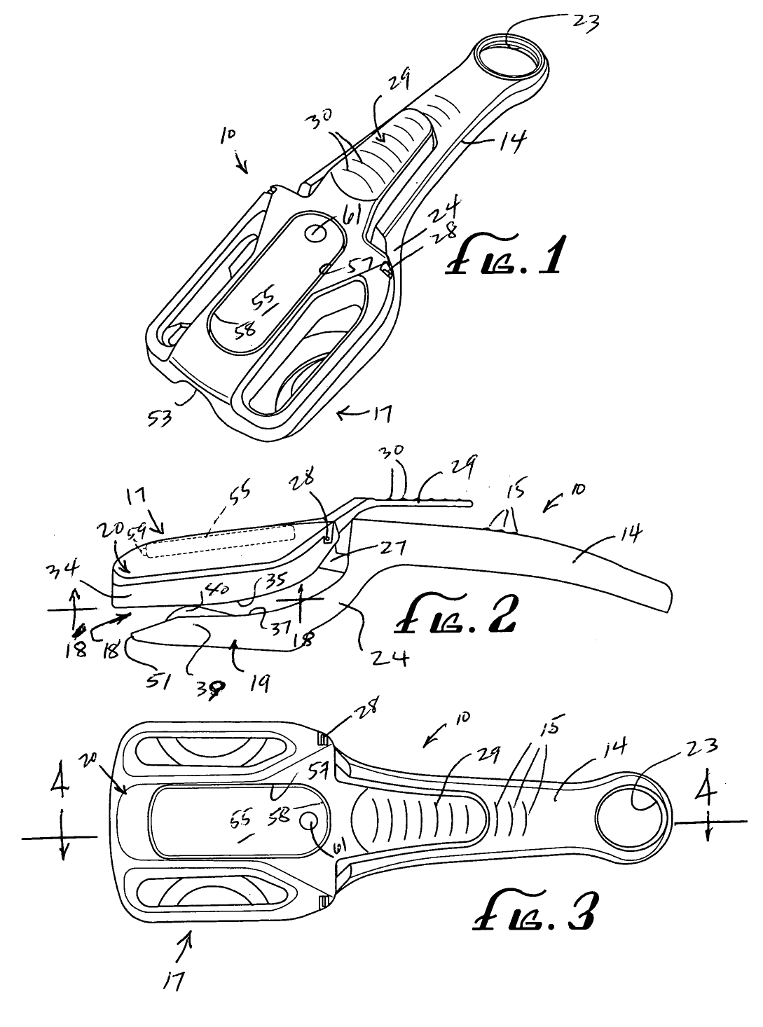

Another feature of the preferred embodiment of the invention shown in FIGS. 1 through 18 is the provision of an optional but highly desirable disposable bag cartridge 22 (see FIGS. 7 through 16) that contains a bag 12 in folded condition and is fitted into the gripping head 17 ready for opening and use on demand. This cartridge also provides a convenient grip for pulling the loaded bag through the gripping head and from the tool during use, and carries the closure clip 21 for sealing the loaded bag for disposal. It is to be noted that a conventional flexible-walled bag can be fitted in the tool and manipulated in a similar manner if a bag cartridge is not available. The invention will be described hereinafter using the bag cartridge, which is the preferred use of the invention.

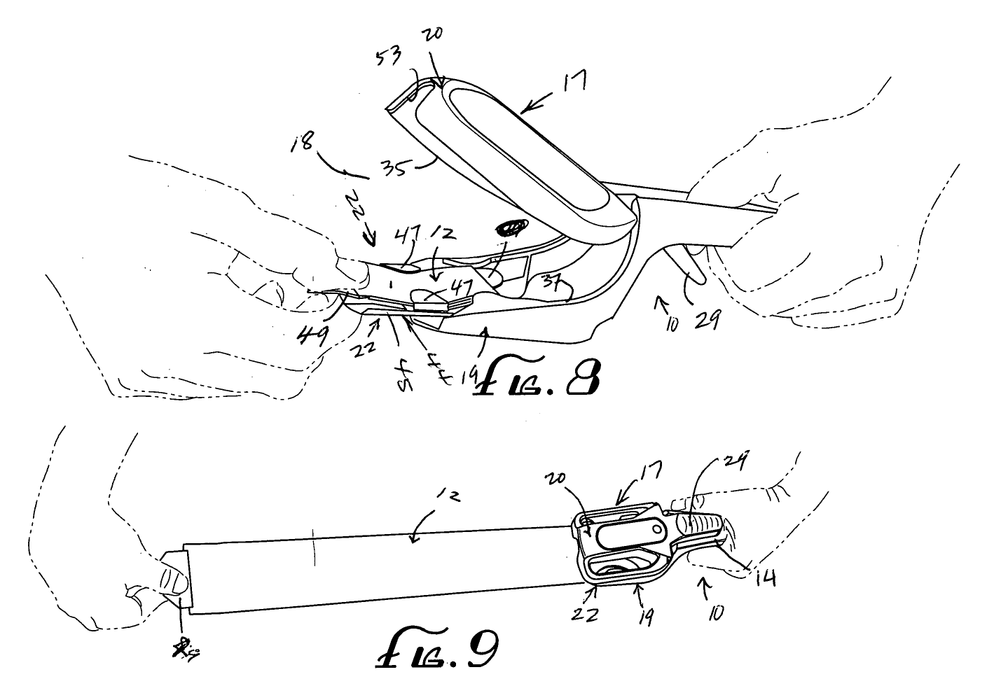

As shown in FIGS. 1-4, the first embodiment of the tool 10 comprises an elongated handle 14 with a thumb hole 23 at one end and a downwardly offset portion 24 (see FIG. 2) at the other end, terminating in the jaw 19 and a free edge 25 that forms one side of the receiving opening 18. Overlying the lower jaw 19 is the upper jaw 20 which is movably mounted on the handle 14, herein on two laterally spaced L-shaped brackets 27 that project forwardly at the offset in the handled and support a hinge pin 28 for the movable jaw that is fastened at its ends to the movable jaw. The movable jaw has an integral operating lever 29 that extends over a clearance opening in the handle, and herein is formed with a series of ridges 30 for effective contact with a user's thumb (see FIG. 8).

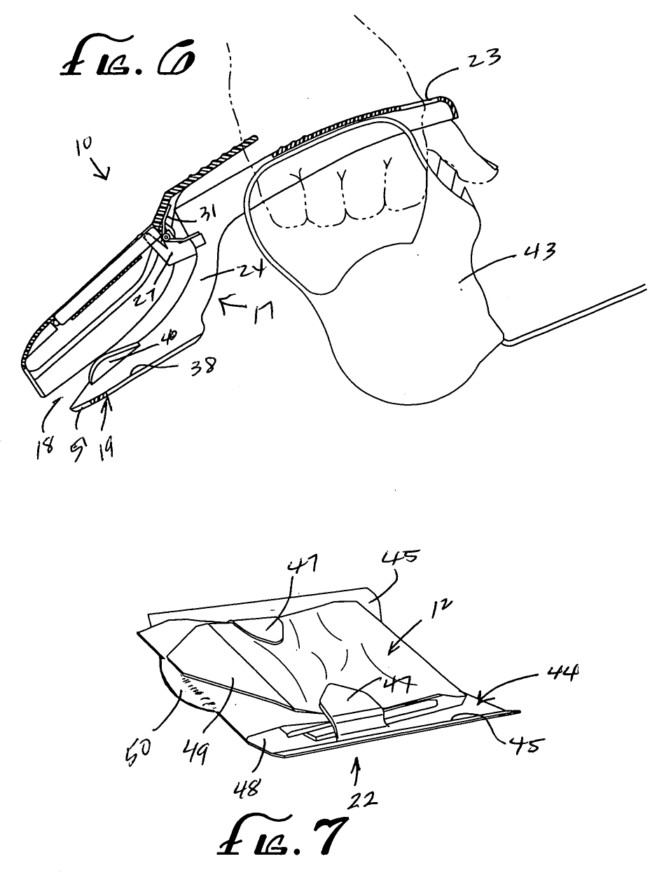

While the movable jaw 20 may be mounted for manual movement in both directions about the pivot pin, it is preferred to provide for spring closing, and herein a torsion spring 31 (FIGS. 4 and 6) is coiled around the jaw hinge for this purpose, with its opposite ends engaging and stressed between a seat 32 on the handle 14 and the underside of the operating lever 29. This urges the lever counterclockwise (as upwardly viewed in FIG. 4) about the hinge pin into a “closed” position shown in FIG. 4 in which the top wall of the movable jaw abuts against stops 33 on the upper ends of the L-shaped brackets. A surrounding flange or skirt 34 on the movable jaw has a lower edge 35 that preferably is slightly spaced from the opposed edge 37 of the lower jaw in the closed position, as shown. The bottom wall 38 (FIG. 4) of the lower jaw 19 is substantially flat between two upturned side flanges 39 to receive the bag cartridge 22, and has two inwardly projecting hold-down ears 40 that are spaced above the bottom wall. It can be seen in FIGS. 1, 3 and 11, and most clearly in FIG. 17, that this bottom wall is formed as a solid front edge portion 38^{a} at the receiving opening and two arcuate bands 38^{b} that curve rearwardly and outwardly to the side flanges 39, defining a generally V-shaped flaring notch 41 in the bottom wall, for a purpose to be described.

With the operating lever 29 normally held in a slightly upwardly inclined position above the handle 14, it forms a convenient clip for carrying the tool 10 on the belt 42 of a user, as shown in FIG. 5. This is an out-of-the-way but easily accessible position. When the user is carrying a leash reel, as indicated at 43 in FIG. 6, the toll 10 conveniently may be held with the user's thumb through the hole 23, as shown in FIG. 6.

Referring to the bag cartridge 22 shown most clearly in FIG. 7, it will be seen that a thin, walled preferably plastic bag 12 is folded into flat, square storage configuration and lies on top of a generally rectangular and flat carrier slide 44 for insertion into the gripping head of the tool 10, to hold a folded bag in readiness for opening and use. The illustrative carrier slide is in the form of a stiff plastic plate having upturned side edge portions 45 and two upwardly offset bag-retaining flaps 47 that are punched out of the plate and extend over and releasably hold the folded bag, as shown in FIG. 7. The preferred bag has a closed end that preferably is attached to the front edge portion 48 of the slide plate, as by heat sealing or an adhesive, and a pull tab 49 that is affixed to one side of the open end portion of the bag ( see FIG. 9) and positioned on the front portion of the slide plate, when the bag is folded, to lie in the receiving opening 18 when the cartridge is in place in the tool 10 (see FIG. 8).

As shown most clearly in FIGS. 8, 9 and 17, the bag cartridge 22 slides into the gripping head 17 above the bottom wall 38 of the lower jaw 19 and beneath the two ears 40, preferably with the upturned edges 45 and the flaps 47 engaging the undersides of the hold-down ears 40 for resistance to sliding. The bag cartridge is held releasably in place in the gripping head by yieldable detents, herein two depending, resiliently flexible tabs 48 on the underside of the slide plate (see FIGS. 15 to 17) that snap into the recesses 49 in the bottom wall when the cartridge is in place, as shown in FIG. 17, thus preventing forward sliding of the slide plate. A depending resiliently flexible positioning flap 50 (FIGS. 7 and 15) on the front edge of the slide plate engages the front edge of the bottom jaw 19, herein in an arcuate recess 51 therein, and releasably detains the cartridge against further movement into the gripping head. Thus, the cartridge is latched releasably in place by the tabs 48 and the flap 50, which form opposed detents abutting against opposed surfaces of the lower jaw.

FIG. 9 shows the extendability of the folded bag 12 from the cartridge 22 preparatory to use, and generally illustrates a preferred length of the bag, substantially longer than the length of the tool 10. The width of the open bag preferably is at least three times the width of the tool, and herein is at least four times, the extended bag shown in FIG. 9 being folded into a one-quarter width strip (and was folded endwise from the condition in FIG. 9 into the storage condition in FIGS. 7 and 8).

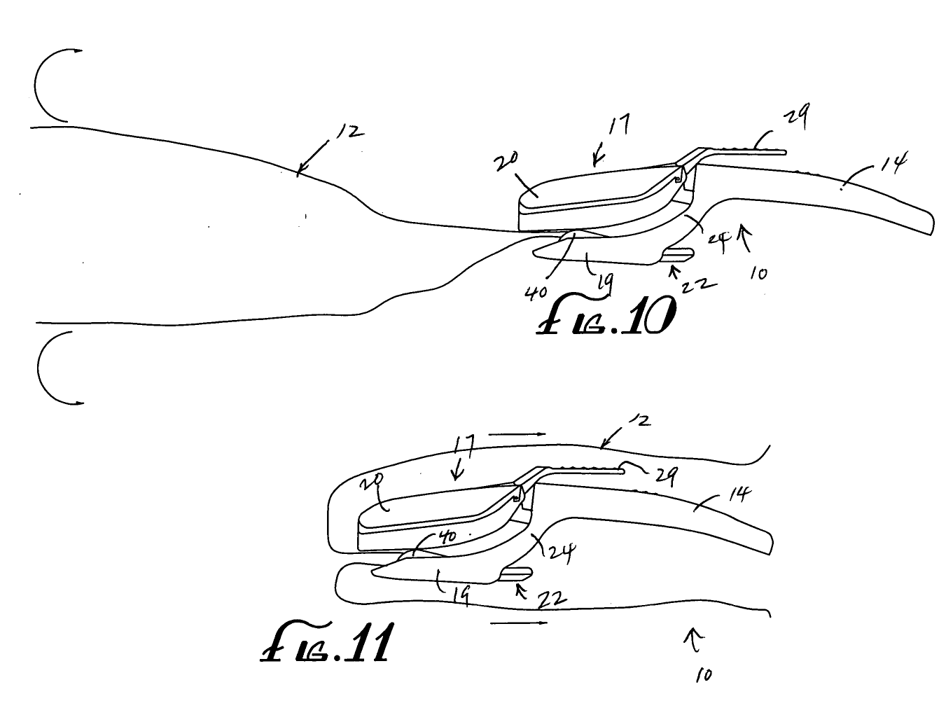

After being extended for use as shown in FIG. 9, the bag 12 can be opened into the condition shown in FIG. 10 and then folded back over the tool 10 as shown in FIGS. 11-13 preparatory for use. Preferably, one wall of the bag is pushed into the receiving opening as shown in FIG. 12 while the jaws are held open by the user's thumb on the operating lever, to form a receiving pocket 52 in the receiving opening, as shown in FIGS. 12 and 13. Then the tool is placed over the refuse 11, as shown in FIG. 13, which is resting on the ground, grass or other surface indicated at S, and the operating lever is released to permit the jaws 19 and 20 to close under the action of the spring 32. This brings the jaws together around the piece of refuse to grip the refuse between the jaws.

It will be seen that the slight spacing of the jaws 19 and 20 in the closed position is less than the usual thickness of the piece of refuse 11, so that the refuse will be gripped, but preferably not smashed, between the jaws. Two generally semi-circular recesses 51 and 53 are formed in the central portion of the jaws, in the edges forming the receiving opening, to enhance this gentle gripping action. This permits the open-end portion of the bag and the contained refuse 11 to be pulled into, and eventually through, the tool 10 for closing and removal. An incidental benefit of these recesses and the slight spacing of the closed jaws is that cat feces can be picked up in a litter box and held while the cat litter, or sand, is shaken out of the bag and back into the box.

From the pick-up position in FIG. 13, after the refuse is clamped between the jaws, the user grips the rear end of the carrier slide 44, as shown in FIG. 14, and pulls the slide rearwardly out of the gripping head 17, thus pulling the open-end portion of the extended bag 12 into and through the head 17 and drawing the contained refuse 11 through the head, as indicated in broken lines in FIG. 15. As shown in FIG. 15, the bag is held releasably in the flaring V-shaped notch defined in the fixed jaw 19 by the arcuate bands 38^{b}. At this stage, the bag and refuse can be simply separated from the tool and discarded, if desired, but the invention provides for convenient closing and sealing of the bag before separation from the tool.

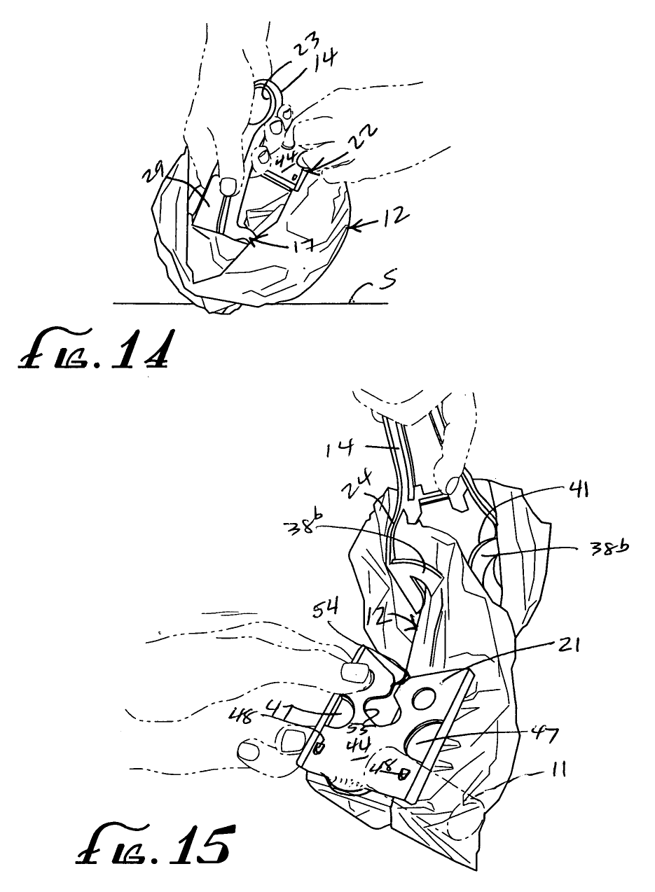

This is accomplished, as shown in FIGS. 15 and 16, by inverting the carrier slide 44 to direct the closure clip/notch 54 (FIGS. 15-17) formed in the inner or rear edge of the carrier slide toward the bag while the open end portion still is held between the jaws 19 and 20, and forcing the clip over the bag (or the bag into the notch in the clip). The notch has converging side edges leading to a narrow throat, with an enlarged inner opening for receiving and holding the bag. The bag thus is closed by the clip, beyond the contained refuse 11, and is effectively sealed. The open end portion of the bag, beyond the clip, never is in contact with the refuse and therefore cannot be contaminated by the refuse. In this position (FIG. 16), the bag 12 can be carried by the tool 10 to a refuse container, or separated and carried by the carrier clip 44 or by the open-end portion of the bag beyond the clip.

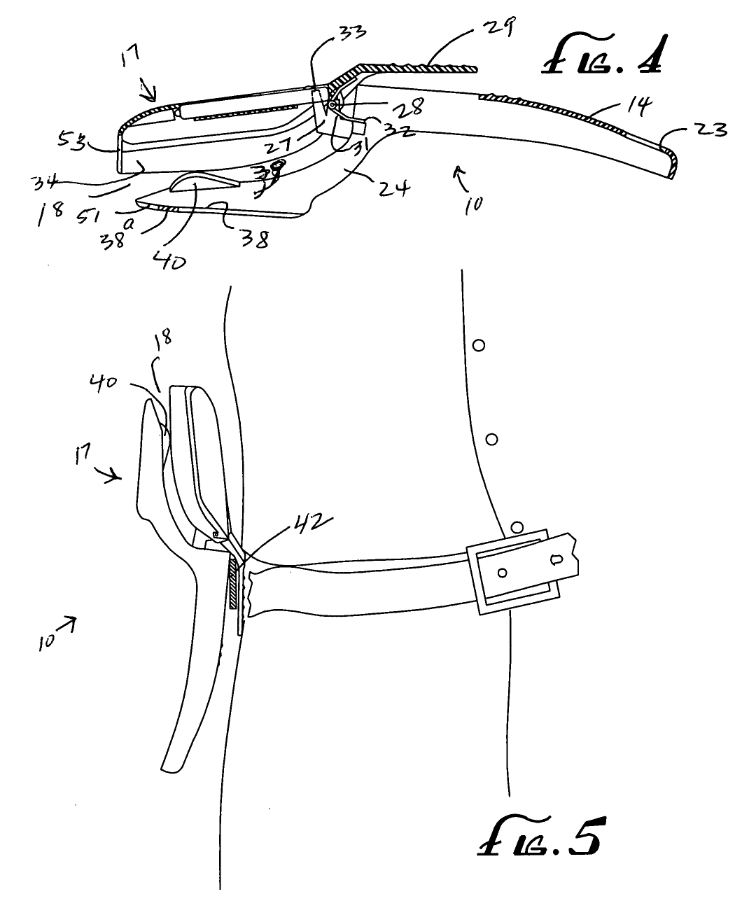

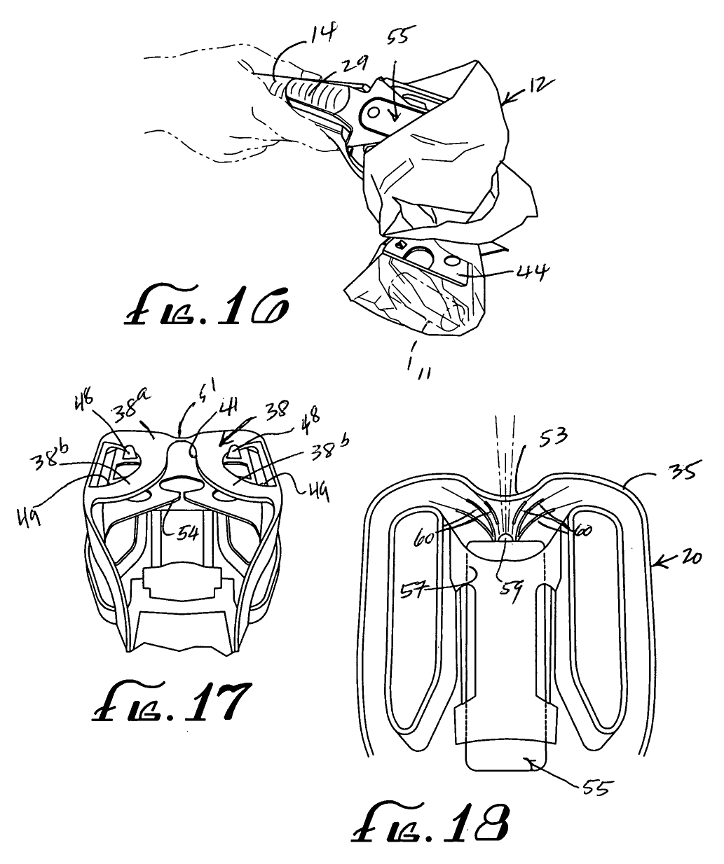

Another feature of the invention is the provision of a selectively operable miniature flashlight 55 that can be used to illuminate the ground while picking up refuse, and also to generally illuminate the gripping head 17 during the bagging operation. For this purpose, a seat 57 (FIGS. 1 and 3) is formed in the upper jaw 20 of the gripping head to receive a flashlight with a “snap”, interference fit beneath a resiliently flexible retaining lip 58 surrounding the top opening in the upper jaw. The front wall of the seat is open to expose the lamp 59 of the flashlight and permit projection of a beam through the upper semi-circular opening 53, and webs 60 (FIG. 18) of translucent material preferably are disposed within the path of this beam to diffuse the beam and illuminate the gripping head as well as the surface area in front of the head. An “on-off” 61 switch is provided on top of the flashlight for easy access.

While the parts of the tool may be made of various materials, including rubber and a variety of different plastics, the preferred embodiment uses relatively rigid molded plastic for the handle 14, the integral jaw 19, and the movable jaw 20, the latter preferably being translucent plastic for light diffusion. Stiff but resiliently flexible sheet plastic is used for the carrier slide 44, with integral flexible detents 48 and bag-retaining flaps 47. The tab 49 may be composed of plastic, cardboard or other lightweight material, and the bags 12 preferably are very thin-walled plastic film. The elongated oval openings in the upper jaw 20 of the gripping head 17 are simply for material and weight reduction and visibility of the interior.

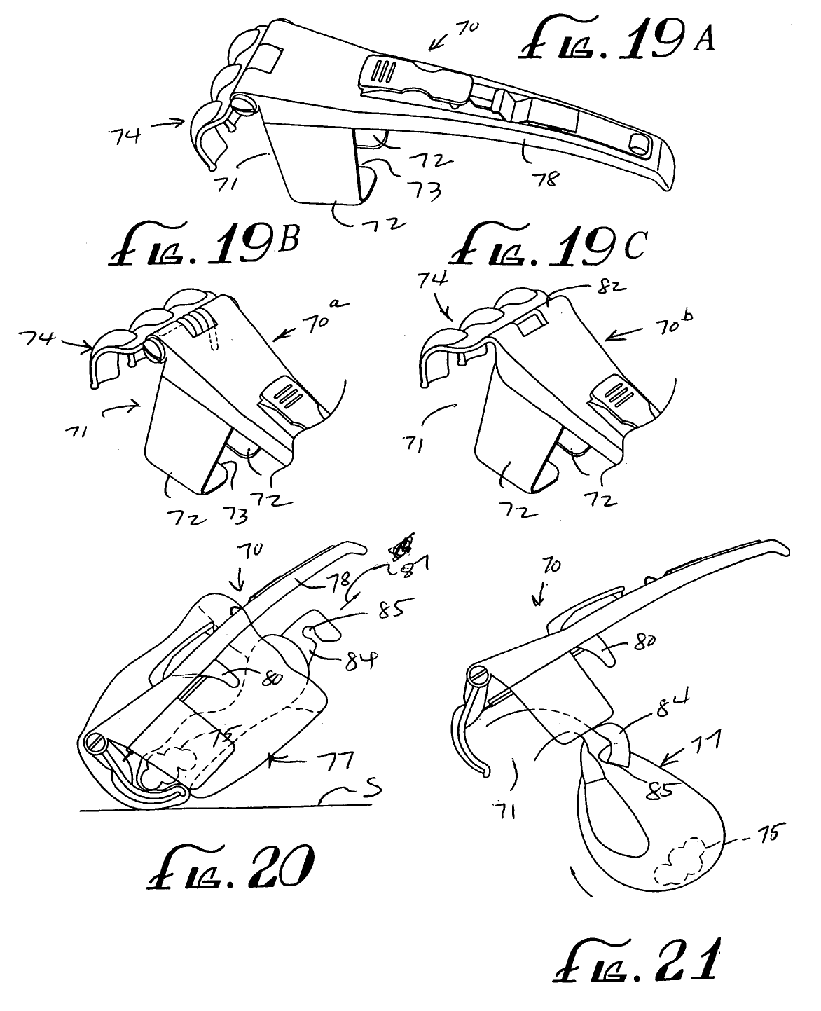

Shown in FIGS. 19 through 21 is a refuse tool 70 constituting an alternative embodiment of the invention in which a receiving opening 71 is defined between a fixed lower jaw in the form two depending L-shaped members 72 spaced apart to leave a slot 73 between them, and a movable jaw74_ that is hinged on the tool and extends outwardly in front of the L-shaped members. The movable jaw, resembling a set of depending fingers, forms a pusher for moving an article of pet refuse 75 into the opening 71 between the jaws and into the L-shaped members, while a disposable bag 77 (FIGS. 20 and 21) is positioned to line the opening and receive the pet refuse, as in the first embodiment. The slot 73 provides a convenient entry and exit for the open-end portion of a disposable bag 75, which in this instance need not be folded.

This tool 70 also has an elongated handle 78 with a gripping head 79 on one end, formed by the pushing jaw 74 and the L-shaped members 72, with a manually operable trigger 80 for the pushing jaw, a simple jaw hinge pin 81 in FIG. 19A, and with a return spring 82 coiled around the hinge pin 81 in FIG. 19B, which is a modified form 70^{a} of the tool 70 in FIG. 19A. This spring holds the movable jaw yieldably in the “open” position. In FIG. 19C, an integral plastic hinge 82 is formed for the jaw 74, this being another modification of the tool, indicated as 70^{b} FIG. 20 shows a flexible bag 77 in place in the receiving opening and folded over the tool 70, with a closed end of the bag under the handle 78 and carrying a closure clip 83 that has a notch 84 for slipping over the bag 77 to close and seal it. As in the first embodiment, the refuse first is positioned in the receiving opening 71 by placing the tool over the refuse, on the ground or other surfaces, but this embodiment uses the trigger 80 and the movable jaw 74 to push the refuse into the bag and hold it in place. Then the bag is pulled partially through the members 72, as indicated by the arrow 87 in FIG. 20, and the closure clip 84 is fastened around the open-end portion of the bag as shown in FIG. 21. Then the bag can be pulled out, using the slot 73 if desired, for disposal.

Accordingly, it will be seen that the present invention provides a simple and effective pet refuse tool that is easy to use and enables the user to pick up, bag, and dispose of pet refuse without need for touching of the refuse or the portion of the bag containing the refuse. This tool can be manufactured in a form that is lightweight and durable, and equipped with disposable refuse bags in cartridge form for even greater convenience.

It also will be evident that, although various embodiments of the invention have been illustrated and described, other modifications and changes may be made by those skilled in the art within the spirit and scope of the invention.

We claim as our invention:

1. A tool for use in picking up and disposing of pet refuse and the like, comprising:
an elongated handle sized to be held in one hand of a user and having a thumb hole adjacent one end of the handle for suspending the tool from a user's thumb;
a gripping head on the end of the handle opposite said one end and comprising a fixed gripping jaw on the handle, and a movable gripping jaw overlying said fixed jaw, said movable jaw being hinged on said handle for movement away from said fixed jaw into an open position and toward said fixed jaw into a closed position, said movable jaw having an operating lever extending over said handle and movable toward said handle to move said movable jaw toward said open position, and further including a spring yieldably urging said movable jaw toward said closed position;
said jaws having opposed edges at the end of said gripping head remote from said handle defining a receiving opening for the refuse;
a stop limiting movement of said movable jaw in said closed position with said opposed edges spaced a preselected distance apart to accommodate a disposal bag inserted in said gripping head and opening out of the gripping head to receive the refuse;
and said gripping head having an open inner side opposite said receiving opening whereby the disposal bag placed in said gripping head with a closed end of the bag adjacent said open inner side of said head may be pulled through the head to confine the refuse in the bag and pull the bag from the head with the refuse contained therein.

2. A tool as defined in claim 1 further including a disposable flexible bag in said gripping head with a closed end of the bag adjacent said open inner side of the head and an open end of the bag outside the head, said bag being folded around the outside of the tool and formed with a receiving pocket in the receiving opening of the head.

3. A tool as defined in claim 1 further including a seat on one of said jaws inside said gripping head for receiving and holding a flat disposable bag cartridge, said seat comprising means for receiving and releasably holding a generally flat cartridge slide and permitting the slide to be pulled manually through the head for removal through said open inner side.

4. A tool as defined in claim 3 wherein said means for receiving and releasably holding a flat cartridge slide comprise a substantially flat wall for said fixed jaw, flaps for overlying said wall in spaced relation therewith and spaced from each other across said wall, whereby the cartridge slide is insertable under the flaps, and opposed stops on said wall engageable with releasable detents on said slide thereby to latch the slide releasably in the gripping head.

5. A tool as defined in claim 4 further including a generally flat cartridge slide disposed in said gripping head and releasably held in said seat, and a flexible disposal bag folded onto said slide in flattened condition, said slide including means thereon for holding the flattened and folded bag for extension out of the gripping head and unfolding for use in receiving and disposing of the refuse.

6. A tool as defined in claim 5 further including a tab affixed to the open end of the bag and disposed in said receiving opening for use in extending and opening the bag.

7. A tool as defined in claim 5 wherein said slide is secured to said bag and accessible from said inner side of said gripping head for use in pulling the bag through said gripping head with the refuse therein.

8. A tool as defined in claim 7 wherein said slide has an inner edge that is formed as a closure clip for closing the bag with the refuse therein.

9. A tool as defined in claim 1 wherein one of said jaws is formed with a mounting seat for receiving and holding a flashlight with lamp of the flashlight directed away from said handle to illuminate the refuse during the pickup operation.

10. A tool as defined in claim 1 wherein said operating lever is spaced from said handle to serve as a belt clip for the user.

11. A tool as defined in claim 1 wherein said opposed edges defining said receiving opening are formed with aligned arcuate recesses forming an enlarged central portion of said receiving opening.

12. The combination of a tool and a flexible refuse bag for use in picking up pet refuse and the like and disposing of the refuse in the bag, comprising:
a handle to be held in one hand of a user and having a gripping head at one end of the handle, said gripping head having a receiving opening facing away from the handle and an open inner side facing toward the handle;
a flexible plastic bag disposed in said gripping head and having an open end portion disposed outside the gripping head, said bag having an opposite end portion extending through the gripping head and to said open inner side thereof, said open end portion being foldable over the gripping head to define a pocket in said bag at said receiving opening;
at least one movable jaw on said handle forming a part of said gripping head;
and a manual operator for moving said jaw back and forth at said receiving opening with said pocket in said opening, thereby to confine the refuse in the receiving opening;
said opposite end portion of said bag being accessible from said inner side of said gripping head to be pulled through the gripping head with the refuse confined in said open end portion, thereby to pull the refuse with the bag through the gripping head, whereby the bag can be removed from the tool with the refuse contained therein without need for contact by the user with the refuse.

13. A tool and flexible refuse bag as defined in claim 12 wherein the gripping head comprises a fixed jaw and a second jaw movable toward and away from the fixed jaw to close and open said receiving opening, said fixed jaw defining said open inner side adjacent said handle.

14. A tool and flexible refuse bag as defined in claim 13 wherein said second jaw is hinged on said handle for swinging movement of said movable jaw toward said fixed jaw, said movable jaw having an extension forming an operating lever for said movable jaw.

15. A tool and flexible refuse bag as defined in claim 12 wherein said bag is affixed to a cartridge slide insertable through said receiving opening into said gripping head and said gripping head has a seat therein for releasably holding said slide in said head, said bag initially being folded onto said cartridge slide and being extendable out of said receiving opening for use.

16. A tool and flexible refuse bag as defined in claim 15 wherein said seat is formed on said fixed jaw and comprises flaps for overlying said cartridge slide, and yieldable detents for holding the slide releasably in place in the head.

17. A tool and flexible refuse bag as defined in claim 15 wherein said cartridge slide has means therein for holding the bag initially and releasably in the folded condition, and said bag has an end portion accessible at said receiving opening to be gripped and pulled from the head.

18. A tool and flexible refuse bag as defined in claim 17 wherein said accessible end portion has a pull tab secured to the bag.

19. A tool and flexible refuse bag as defined in claim 12 wherein said receiving opening is formed as one open side of a box-like head, said head having a second open side facing away from said receiving opening and a slot formed in a third side for insertion and removal of said bag, and said bag extends through said head with the open-end portion folded outwardly over the tool.

20. A tool and flexible refuse bag as defined in claim 19 wherein said operator is a trigger for pulling the movable jaw toward said open side.

21. A tool for use in picking up and disposing of refuse, comprising:
a handle sized to be held in one hand of a user;
a gripping head on one end of the handle comprising a pair of relatively movable elements defining a receiving opening between them, one of said elements being connected to an operator for causing opening movement;
said gripping head having an open side opposite said receiving opening, and being adapted to receive a flexible bag with an open end portion outside said receiving opening and an oposite end portion in said gripping head, whereby said open end portion may be folded over the gripping head to line the receiving opening and then to be pulled from said opposite end portion through said gripping head for removal from the tool.

22. A tool as defined in claim 21 further including a disposable bag cartridge having a folded refuse bag therein positioned in said gripping head, said bag having an open end portion that is extendable out of said gripping head to be folded around the tool.

23. A tool as defined in claim 22 wherein said gripping head has a seat therein for receiving said bag cartridge, and said bag cartridge has a cartridge slide attached to the bag and releasably latched in said seat to hold the bag therein and to be pulled out through said open side.

24. A tool as defined in claim 23 further including a tab affixed to the open end of the bag and disposed in said receiving opening for use in extending and opening the bag.

25. A tool as defined in claim 23 wherein said slide has an inner edge that is formed as a closure clip for closing the bag with the refuse therein.

26. A tool as defined in claim 21 wherein said gripping head is formed with a mounting seat for holding a flashlight with a lamp of the flashlight directed through the receiving opening to illuminate the refuse.

27. A tool as defined in claim 21 wherein said operator is a lever spaced from said handle and forming a belt clip for the tool.

28. A tool as defined in claim 21 wherein said relatively movable elements are two gripping jaws, one being fixed to said handle and the other being hinged thereon and spring-loaded toward a closed position, said other jaw having an extension forming a lever that is the operator, said handle having an offset at said fixed jaw forming said open side.

29. A tool as defined in claim 21 wherein said relatively movable elements are a jaw element hinged on said handle and two L-shaped elements affixed to said handle and defining said receiving opening on one side and said open side opposite said receiving opening, with a slot between said L-shaped elements for insertion and removal of a disposal bag, said operator being a trigger connected to said jaw element to move it toward and away from said receiving opening.

30. The method of picking up and disposing of refuse and the like comprising the steps of:
providing a manually operable portable tool having a handle to be held in one hand of a user and having a gripping head on said handle with a receiving opening facing away from the handle and an opposite open side, and having a manually movable jaw for confining pet refuse at the receiving opening;
providing a disposable flexible plastic bag with an open end portion and an opposite end portion;
placing the bag in the gripping head with the open end portion extending out through the receiving opening and the opposite end portion at the opposite open side;
folding the open end portion of the bag over the gripping head and the handle and thereby forming a pocket at the gripping opening to be placed over the refuse by the tool;
manually moving the movable jaw to confine the pet refuse in the gripping opening;
pulling the bag at least partially through the gripping head from said opposite end portion to draw the refuse, in the bag, into the head;
and pulling the bag with the refuse from the tool through said opposite open side to separate the same for disposal.

31. The method defined in claim 30 including the further steps of providing a closure clip on said opposite end portion of the bag; and
applying said clip to said bag between the contained refuse and the open end portion of the bag thereby to close the bag before disposal.

32. The method defined in claim 31 wherein the step of applying the clip to the bag is performed after the portion of the bag containing the refuse has been drawn through said opposite end portion of said head and before the open end of the bag has been withdrawn from the head, thereby to close the bag while the open end is held by the tool.

33. The method defined in claim 30 wherein the step of manually moving the movable jaw is performed to push the refuse into the receiving opening lined with the flexible bag.

34. The method defined in claim 30 wherein the step of manually moving the movable jaw is performed to clamp the refuse in the receiving opening lined with the flexible bag.

35. The method of picking up and disposing of pet refuse and the like comprising the steps of:
providing a manually operable tool having a gripping head with a receiving opening facing in one direction and an opposite open side;
providing a disposable flexible bag with an open end portion and an opposite end portion;
placing the bag in said gripping head with the open end portion extending out of said receiving opening and said opposite end portion at said opposite open side;
folding said open end portion over said gripping head and thereby forming a pocket at the gripping opening;
placing the pocket over the refuse and gripping the refuse in the gripping opening;
pulling the bag at least partially through the gripping head from said opposite end portion to draw the refuse, in the bag, into the head;
and pulling the bag with the refuse from the tool for disposal.

36. The method defined in claim 35 including the further steps of providing a closure clip on said opposite end portion of the bag; and
applying said clip to said bag between the contained refuse and the open end portion of the bag thereby to close the bag before disposal.

37. The method defined in claim 36 wherein the step of applying the clip to the bag is performed after the portion of the bag containing the refuse has been drawn through said opposite end portion of said head and before the open end of the bag has been withdrawn from the head, thereby to close the bag while the open end is held by the tool.
